(19) United States
(12) Patent Application Publication
(10) Pub. No.: US 2006/0042096 A1
(43) Pub. Date: Mar. 2, 2006

(54) Cutter assembly for hair clipper

(75) Inventor: Yi-Tang Liao, Taichung County (TW)

Correspondence Address: BACON & THOMAS, PLLC, 625 SLATERS LANE, FOURTH FLOOR, ALEXANDRIA, VA, 22314, US

(73) Assignee: JENG SHYUAN PRECISION CO., LTD., TAICHUNG CITY (TW)

(21) Appl. No.: 11/213,722

(22) Filed: Aug. 30, 2005

(30) Foreign Application Priority Data
Sep. 1, 2004 (TW) 93213937

(51) Int. Cl. B26B 19/00

(52) U.S. Cl. 30/223

(57) ABSTRACT

A cutter assembly for hair clipper is disclosed to include a first cutter holder and a first cutter mounted in the first cutter holder, the first cutter having two flock pushing guides at two sides of the cutting edge thereof for guiding out waste cut hairs, and a movable cutter set movable alternatively leftwards and rightwards relative to the first cutter holder and formed of a second cutter holder and a second cutter mounted in the second cutter holder.

### BACKGROUND OF THE INVENTION

1. Field of the Invention

The present invention relates to hair clipper and more particularly to a cutter assembly for hair clipper.

2. Description of the Related Art

A hair clipper for cutting hair is generally comprised of a clipper body, and a cutter assembly mounted in the clipper body and formed of two cutter sets that are movable relative to each other. According to this design, there is an assembly gap is left between the cutter assembly and the clipper body. This assembly gap may cause the hair to be stretched by the cutter assembly during cutting. Further, waste cut hairs may enter this assembly gap and may be jammed in between parts of the hair clipper, producing a resistance to the movable cutter set.

Further, the parts of the aforesaid conventional hair clipper are expensive to manufacture and complicated to assemble. Therefore, it is desirable to provide a cutter assembly for hair clipper that eliminates the aforesaid drawbacks.

### SUMMARY OF THE INVENTION

The present invention has been accomplished under the circumstances in view. It is one object of the present invention to provide a cutter assembly for hair clipper, which prevents stretching of hair by the hair clipper and jamming of waste cut hairs in the cutter assembly. It is another object of the present invention to provide a cutter assembly for hair clipper, which is easy and inexpensive to manufacture and convenient to assemble.

To achieve these and other objects of the present invention, the cutter assembly for hair clipper comprising a first cutter holder, which comprises a holder base, a clipper mounting portion, a spring seat and a cutter seat, and a first cutter, which comprises a cutter body mounted in the first cutter holder, a cutting edge and two flock pushing guides disposed at two opposite sides of the cutting edge for guiding out waste cut hairs, and a movable cutter set, which is comprised of a second cutter holder and a second cutter and movable alternatively leftwards and rightwards relative to the first cutter holder.

### BRIEF DESCRIPTION OF THE DRAWINGS

FIG. 1 is a perspective view of a cutter assembly for hair clipper according to the present invention.

FIG. 2 is a sectional side assembly view of the cutter assembly for hair clipper according to the present invention.

FIG. 3 is an exploded view of the cutter assembly for hair clipper according to the present invention.

FIG. 4 is an elevational view of a part of the present invention, showing the first cutter holder and the first cutter assembled.

FIG. 5 is a top view of FIG. 4.

FIG. 6 is a top view of the first cutter of the cutter assembly for hair clipper according to the present invention.

FIG. 7 is a side view of the first cutter of the cutter assembly for hair clipper according to the present invention.

### DETAILED DESCRIPTION OF THE INVENTION

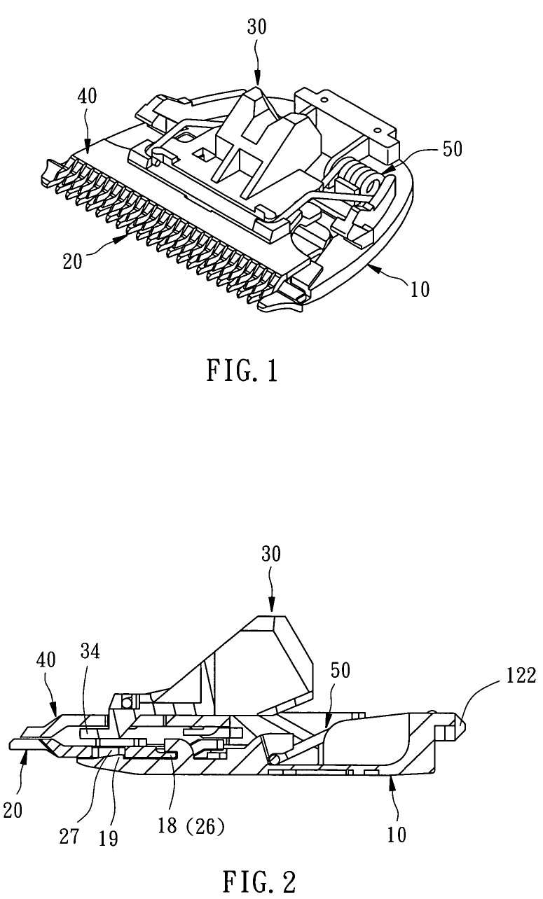

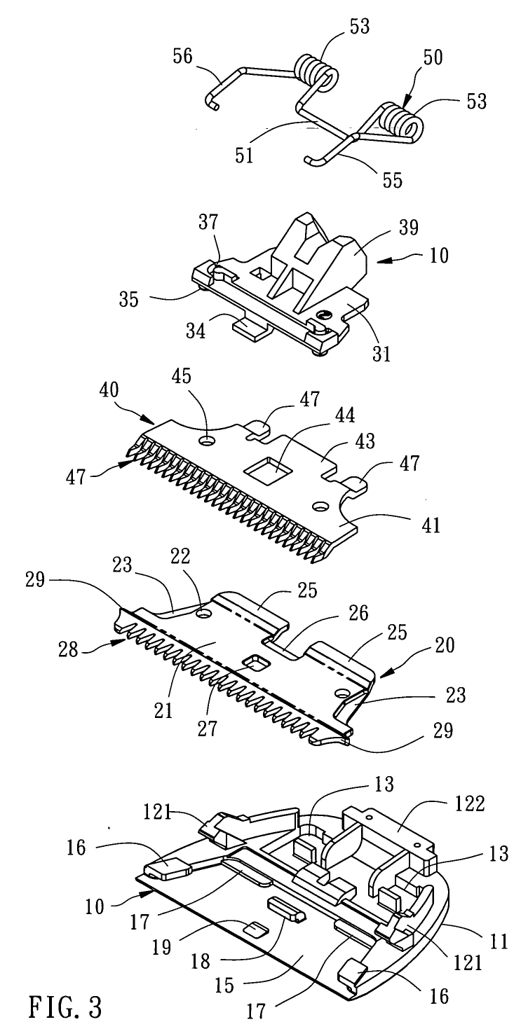

Referring to FIGS. 1˜7, the invention provides a cutter assembly connectable to a clipper body of a hair clipper. The cutter assembly comprises a first cutter holder 10, a first cutter 20, a second cutter holder 30, a second cutter 40, and a spring member 50.

The first cutter holder 10 comprises a holder base 11, a first mounting portion 121 and a second mounting portion 122 that form a clipper mounting portion, a spring seat 13, a cutter seat 15, two engagement portions 16, two first connecting portions 17 and one second connecting portion 18, and a retainer 19.

The first cutter 20 is mounted in the first cutter holder 10, comprising a cutter plate 21, two mounting holes 22, two engagement portions 23, two first connecting portions 25, a second connecting portion 26, a retaining portion 27, a notched cutting edge 28, and two flock pushing guides 29. The flock pushing guides 29 are triangular members respectively protruding over the two opposite lateral sides of the holder base 11 of the first cutter holder 10 at a predetermined distance.

Further, the first cutter 20 is made of a metal plate by stamping, having a concave convex contour and holes. This design has the advantages of high mechanical strength, quick fabrication, and low material and processing cost.

The first cutter holder 10 and the first cutter 20 form a fixed cutter set.

The second cutter holder 30 comprises a holder base 31, a cutter seat 34, two locating portions 35, a spring seat 37, and an actuating portion 39 through which the second cutter holder 30 can be reciprocated by an external reciprocating drive.

The second cutter 40 comprises a cutter plate 41 installed in the second cutter holder 30, a mounting portion 43, a linking portion 44 that is a through hole, two locating portions 45 that are locating holes, a sliding guide 47, and a notched cutting edge 47. Further, the second cutter 40 is made of a metal plate by stamping, having a concave convex contour and holes.

The second cutter holder 30 and the second cutter 40 form a movable cutter set.

The spring member 50 comprises a stopping portion 51 stopped against the first cutter holder 10, two spring coils 53 connected at each end of the stopping portion 51, two endpiecdes 55 connected at each end of the two spring coils 53 and respectively stopped against the second cutter holder 30.

When assembled, the invention works as follows:

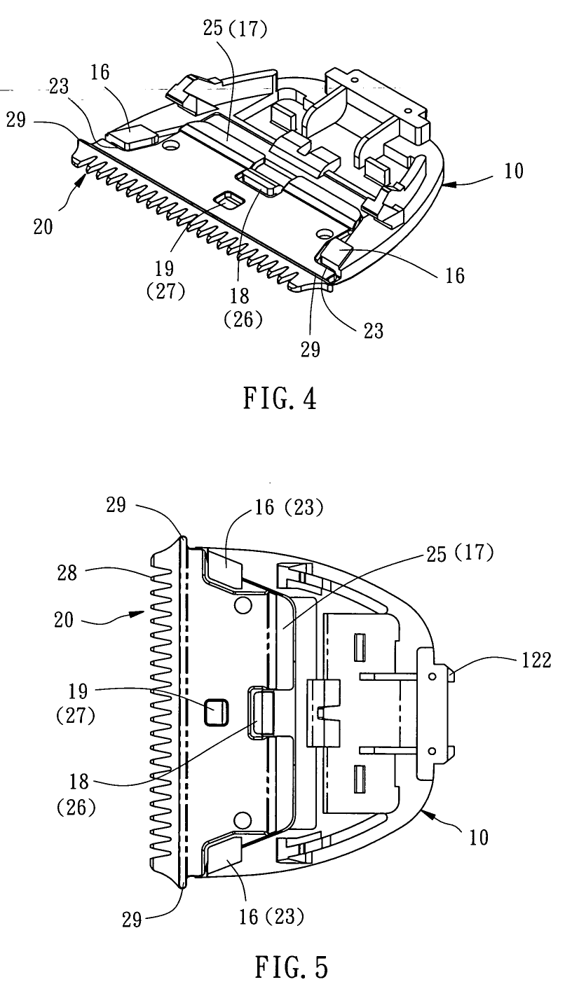

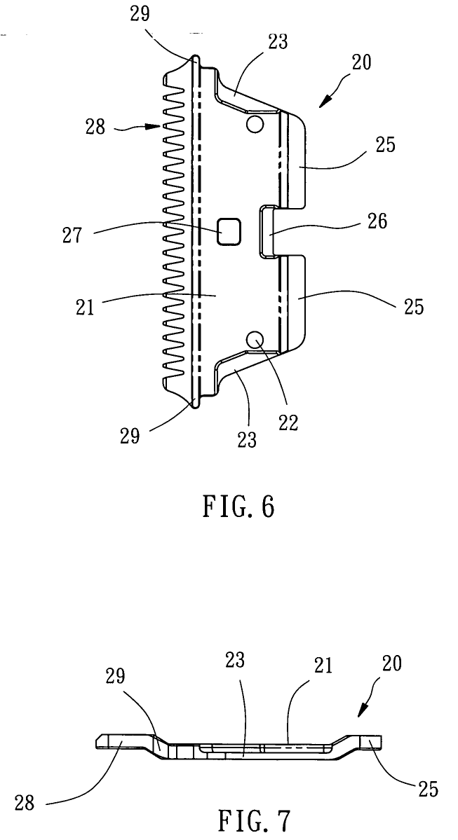

As shown in FIGS. 4 and 5, an assembly gap is left at each of the two opposite lateral sides between the first cutter holder 10 and the clipper body of the hair clipper (not shown). The flock pushing guides 29 guide waste cut hairs out of the cutter assembly, preventing jamming of waste cut hairs in the assembly gaps between the first cutter holder 10 and the clipper body of the hair clipper. Therefore, the cutter assembly of the present invention is convenient in use, and it is not necessary to clean the cutter assembly frequently.

In addition to the triangular design of the flock pushing guides, the flock pushing guides can also be made in an arched, semicircular or trapezoidal shape, or any of a variety of other shapes, achieving the same effect.,

As indicated above, the invention has the following characteristics:

1. The design of the flock pushing guides at the first cutter holder preventing stretching of hair by the hair clipper and jamming of waste cut hairs in the cutter assembly.

2. The first cutter is made of a metal plate by stamping for the advances of being easy to make and to assemble to the cutter holder.

What is claimed is:

1. A cutter assembly mountable on a clipper body of a hair clipper comprising:
a first cutter holder, said first cutter holder comprising a holder base, a clipper mounting portion for fastening to said clipper body of a hair clipper, a spring seat and a cutter seat;
a first cutter, said first cutter comprising a cutter body mounted in said holder base of said first cutter holder, a notched cutting edge, and two flock pushing guides disposed at two sides of said notched cutting edge for guiding out waste cut hairs; and
a movable cutter set alternatively movable leftwards and rightwards relative to said first cutter holder, said movable cutter set comprising a second cutter holder and a second cutter mounted in said second cutter holder.

2. The cutter assembly as claimed in claim 1, wherein said first cutter holder further comprises a retainer; said first cutter comprises a retaining portion fastened to said retainer of said first cutter holder.

3. The cutter assembly as claimed in claim 1, wherein said first cutter holder comprises an engagement portion; said first cutter comprises an engagement portion for engagement with said engagement portion of said first cutter holder.

4. The cutter assembly as claimed in claim 3, wherein said engagement portion of said first cutter are curved inwards in said cutter body subject to a predetermined depth.

5. The cutter assembly as claimed in claim 1, wherein said notched cutting edge of said first cutter is disposed at an elevation spaced from the elevation of said cutter body at a distance.

6. The cutter assembly as claimed in claim 1, wherein said flock pushing guides of said first cutter have one of the shapes including triangular shape, arched shape, semicircular shape and trapezoidal shape.

7. A cutter assembly mountable on a clipper body of a hair clipper, comprising:
a first cutter holder, said first cutter holder comprising a holder base, a clipper mounting portion for fastening to said clipper body of a hair clipper, a spring seat, a cutter seat, an engagement portion, and a retainer;
a first cutter, said first cutter comprising a cutter body mounted in said holder base of said first cutter holder, an engagement portion, and a notched cutting edge, said first cutter being made of a metal plate by stamping; and
a movable cutter set alternatively movable leftwards and rightwards relative to said first cutter holder, said movable cutter set comprising a second cutter holder and a second cutter mounted in said second cutter holder.

8. The cutter assembly as claimed in claim 7, wherein said engagement portion of said first cutter are curved inwards in said cutter body subject to a predetermined depth.

9. The cutter assembly as claimed in claim 7, wherein said first cutter comprises two flock pushing guides disposed at two sides of said notched cutting edge for guiding out waste cut hairs.

10. The cutter assembly as claimed in claim 7, wherein said engagement portion of said first cutter are curved inwards in said cutter body subject to a predetermined depth.
